(19) United States
(12) Patent Application Publication
(10) Pub. No.: US 2013/0117822 A1
(43) Pub. Date: May 9, 2013

(54) METHOD AND SYSTEM FOR SECURE TELETRANSMISSION

(71) Applicant: Christian Soulez, Saint-Germain En Laye (FR)

(72) Inventor: Christian Soulez, Saint-Germain En Laye (FR)

(73) Assignee: KCS MONETIC, Saint-Germain En Laye (FR)

(21) Appl. No.: 13/699,887

(22) PCT Filed: May 24, 2011
(86) PCT No.: PCT/FR11/51174

§ 371 Date: Jan. 23, 2013

(30) Foreign Application Priority Data
May 27, 2010 (FR) 1054098

(51) Int. Cl. H04L 29/06

(52) U.S. Cl. CPC H04L 63/08
USPC 726/4; 726/10; 726/9

(57) ABSTRACT

A system for secure teletransmission destined for a receiving person includes a secure server comprising a program providing a redemption code and a designation code for designating an object to which the teletransmission pertains. A terminal includes an interface allowing a sending person to indicate the designation code and to take cognizance of the redemption code, and an interface for connection to the secure server to send a request and to receive the redemption code, in response. A terminal includes an interface allowing the receiving person to enter the redemption code and the designation code, an interface for connection to the secure server to receive an authorization from the secure server. The authorization confirms correlation of the redemption code entered with the designation code. A deliverer automatically delivers the object, after receipt of the authorization.

### FIELD OF THE INVENTION

The present invention relates to a method and system for secure teletransmission.

### BACKGROUND

The known communication and information processing means provide flexibility and speed for carrying out local or remote transmissions that facilitate exchanges between people.

However, the abilities offered by the communication and information processing means must not be a source of vulnerability when sensitive and/or valuable information is transmitted, as the transmission must then reach the intended recipient without being corrupted. This is in particular the case when the transmission involves transferring money.

In the known state of the art, the publication of patent EP0807910B1 on Jun. 4, 2008 discloses a method for implementing electronic money in which an oversight institution orders a bank to transfer a payment amount to a bank account after verifying the validity of the electronic currency. The requirement that the recipient of the transfer have a bank account is a security factor. However, the method disclosed in this first aforementioned patent has the drawback of not being appropriate when the recipient does not have a bank account.

The publication of patent EP1168762B1 on Jul. 16, 2008 discloses an information supply system in which a terminal device sends financial information for users to an information administration device arranged to perform a payment transfer. However, the method disclosed in this second aforementioned patent has the drawback of not allowing the concrete delivery of an object, in particular a sum of money to a money transfer recipient.

More generally, the known security techniques essentially rely on electronic means that verify one another in a manner that is not particularly transparent to the user. These techniques are not fully satisfactory in terms of user certainty regarding proper receipt of the correct sum by the correct recipient. Furthermore, non-refusal of the transmission by the user, which is crucial in money transfers, is difficult to guarantee when the user, faced with the lack of transparency in the purely electronic verification measures, may be tempted to refute the integrity of the electronic verification means.

Various attempts using electronic communication means have been undertaken without any real success to deliver an object to a recipient, so as not to require the recipient to have a bank account, including when the object is a sum of money.

The grant publication of patent EP0960499B1 on Nov. 2, 2005 mentions a system able to provide requested funds to a recipient by verifying that a first security code included in the transfer data is the same as a second security code included in the recipient data, the transfer data being entered by a sender and the recipient data being entered by the recipient. The method used is not fully satisfactory in terms of security, for example in the event of interception of the security code in the transfer data or the recipient data.

### SUMMARY OF THE INVENTION

The present invention aims to offset the aforementioned drawbacks of the known security devices.

To that end, according to the invention, a secure teletransmission method ordered by a sender destined for a recipient comprises:

a first primary step and a second primary step that are activated when a secure server receives a first request from a first electronic device, the request containing a code for designating an object to which the teletransmission pertains and an address of personal receiving equipment assigned to the recipient;

the first primary step consisting of providing the first electronic device with a redemption code;

the second primary step consisting of providing the personal receiving equipment with a ticket containing data comprising at least the code for designating the object to which the teletransmission pertains; and

a third primary step that is activated when the secure server receives a second request from a second electronic device, said second request containing the redemption code and all or some of the data comprising at least the code designating the object;

the third step consisting of verifying that the redemption code matches at least the code designating the object to provide the object to the recipient when a match between the codes has been positively verified.

Advantageously, the secure teletransmission method comprises:

a first peripheral step that is activated when the sender sends a call from the personal sending equipment to the personal receiving equipment;

a second peripheral step that is activated when the recipient takes the call sent from the personal sending equipment;

the first peripheral step and the second peripheral step consisting of enabling the sender to recognize the recipient so as to ensure that the personal receiving equipment is in fact assigned to the recipient and to send said recipient the redemption code.

According to one possible embodiment, the first electronic device is a first terminal, the second electronic device is a second terminal, and the method comprises:

a formulation step in which the first terminal receiving a verification token asks the sender to indicate the code for designating an object to which the teletransmission pertains;

a request step in which the first terminal sends the secure server a request including the token and the designation code to ask the secure server to provide the redemption code;

a signaling step in which the first terminal communicates the redemption code to the sender; and

a distribution step in which the second terminal completes the transmission by delivering the object, after reception of the redemption code and the designation code entered by the recipient, and after reception of an authorization emitted by the secure server to confirm the correlation between the entered redemption code and the verification token.

Particularly, in the formulation step, the first terminal asks the sender to indicate at least one unambiguous personal code of the recipient and/or the sender; and

in the request step, the first terminal places said unambiguous personal code(s) in the request sent to the secure server.

More particularly, in the distribution step, the second terminal delivers the object after additionally receiving at least one unambiguous personal code entered by the recipient.

Preferably, the unambiguous personal code is a telephone number.

Advantageously, the unambiguous personal code is a telephone number of the recipient and the recipient receives the designation code by telephone on a first communication channel connected to the secure server and the redemption code on a second communication channel connected to the sender.

According to another possible embodiment, the first electronic device is the personal sending equipment making it possible to access an account controlled by the secure server and the second electronic device is a terminal. The method then comprises a step for creating a sub-account accessible from the personal receiving equipment when the secure server recognizes an add request from the personal equipment, and the data supplied in the second main step comprises access information for the sub-account.

In the context of either embodiment, the secure teletransmission method preferably comprises:

a step for displaying data received by the personal receiving equipment from the secure server;

an authorization request step sent to the secure server when the received data is entered with the access code in the second terminal.

Particularly, a temporally- and/or spatially-limited validity is associated with the redemption code.

According to one possible alternative, the object is a sum of money and the designation code is an amount of the sum of money.

According to another possible alternative, the object is a sub-account, the designation code is a username of the sub-account, and the second electronic device is the personal receiving equipment.

Advantageously, in this other alternative, the secure server creates a virtual card number in the third primary step.

The invention also relates to a secure teletransmission system destined for a receiving person ordered by a sending person, which comprises:

a first electronic device available to the sender;

personal receiving equipment allocated to the recipient;

a secure server comprising a program for supplying a redemption code to the first electronic device and supplying a code for designating the object to which the teletransmission pertains to the personal equipment; and

a second electronic device comprising an interface to allow the recipient to enter at least the redemption code, means for connecting to the secure server to send the redemption code and the designation code and to receive authorization from the secure server confirming a correlation between the entered redemption code and the designation code, and automatic delivery means for the object after receipt of the authorization.

Advantageously, the system comprises personal sending equipment allowing the sender to call the personal receiving equipment to ensure that the personal receiving equipment is in fact assigned to the recipient.

According to a first possible embodiment, the first electronic device is a first terminal comprising an interface arranged to ask the sender to indicate at least one unambiguous personal code of the recipient and/or the sender so as to place said unambiguous personal code(s) in a request sent to the secure server.

Particularly, the second electronic device is a second terminal arranged to deliver the object after additional receipt of at least one of the unambiguous personal codes entered by the recipient.

More particularly, the unambiguous personal code is a telephone number, still more particularly more particularly a telephone number of the recipient, and the recipient receives the designation code by telephone on a first communication channel connected to the secure server and the redemption code on a second communication channel connected to the sender.

According to a second possible embodiment, the first electronic device is the personal sending equipment then containing a program making it possible to access an account controlled by the secure server, and the second electronic device is personal receiving equipment. The secure server is then arranged to receive an add request from the personal equipment, to create a sub-account accessible from the personal receiving equipment, and to send the personal receiving equipment data comprising access information for the sub-account.

In either embodiment, the secure server is advantageously arranged to temporally and/or spatially limit a validity associated with the redemption code.

According to one possible alternative of the system, the object is a sum of money and the designation code is an amount of the sum of money.

According to another possible alternative of the system, the object is a sub-account, the designation code is a username for the sub-account, and the second electronic device is the personal receiving equipment.

### BRIEF DESCRIPTION OF DRAWING FIGURES

The invention will be better understood, and other aims, features, details, and advantages thereof will appear more clearly in the following explanatory description done in reference to the appended technical drawings provided solely as an example illustrating one embodiment of the invention and in which:

FIG. 1 is a diagrammatic view of a system implementing the invention;

FIG. 2 shows the steps of the method according to the invention for allowing a sender to transfer a sum of money;

FIG. 3 shows the steps of the method according to the invention for allowing the recipient to receive the sum of money;

FIGS. 4 and 5 show the steps of the method according to the invention for allowing the sender to create a sub-account to the benefit of the recipient; and

FIG. 6 shows the steps of the method according to the invention applicable to embodiments other than those presented.

### DETAILED DESCRIPTION

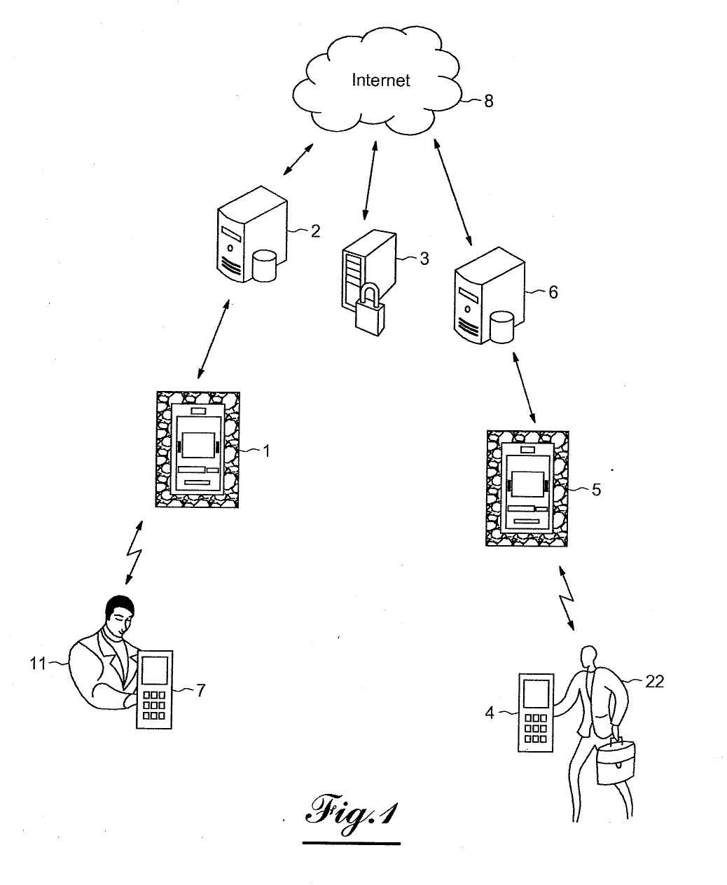

The system shown in FIG. 1 comprises a bank computer 2 that hosts a bank account held by a person 11 to send an order to withdraw a sum of money from said bank account.

The system also comprises a first terminal 1 that allows strong authentication of the person 11 as the holder of said bank account. The terminal 1 is for example a bank machine of the Automated Teller Machine (ATM) type using which the person 11 may provide proof to authenticate that he holds the account by using a bank card associated with a secret code that only the person 11 knows. The terminal 1 is for example also a peripheral of the bank computer, accessible only by a bank employee working at a counter in a branch equipped with the peripheral and who can physically authenticate the person 11 using the latter's identification documents or through the employee's personal knowledge of the person 11. The terminal 11 is for example also a programmed mobile telephone or a mobile telephone whereof the SIM card is programmed in a known manner to offer the functions of a bank card. The possible authentication means are not limited to a secret code. The authentication means may be based on the biometric characteristics of the person 11. The type of the terminal 11 is not limited to those stated above, but encompasses all types of electronic equipment that offer strong authentication services comparable to what is for example the case of a personal computer configured to perform banking operations on the bank account using a secure dialogue with a website of the bank.

The system also comprises a second terminal 5, the essential function of which is to distribute banknotes. Due to its nature, a bank machine is well-suited to form the terminal 5. The terminal 5 allows a person 22 to receive a sum of money without having to provide evidence of holding a bank account, in other words without necessarily having a bank account to perform banking operations.

The terminal 5 is connected to a second bank computer 6 that manages any delivery of money on the terminal 5, in particular by delivering banknotes.

The bank computer 6 may be connected to the bank computer 2 using a specialized inter-bank network or secure connections on the Internet 8. The computer 6 may also, in certain usage cases, be combined with the computer 2, in particular but not necessarily when the terminal 5 is combined with the terminal 1. The scenarios essentially depend on the respective geographical positions of the people 11 and 22.

Remarkably, the system comprises a secure funds transfer server (SFTS) 3 that can be connected to the computers 2 and 6 using connection means comparable to those used by the computers 2 and 6 to communicate with one another, so as to establish a money transfer service that may be performed within a same bank or by a third party operator acting on behalf of several banks.

The money transfer service offered by the server 3 differs from the known money withdrawal services in that the person 22 to whom a sum of money is physically given, in particular in the form of banknotes, is not necessarily the person 11 who authenticates himself to withdraw the sum of money from his account.

The server 3 is provided to deliver a single-use redemption code ALEA to the person 11 authenticated on the terminal 1 by the system to access the account. Outside the system, the person 11 provides the code to the person 22 in a way that allows him personally to verify the recipient, i.e. to recognize that the person 22 is indeed the person for whom the person 11 intends the sum of money. The person 22 then uses the code to withdraw the sum of money on the terminal 5.

This service has multiple uses.

According to a first possible use, the person 22 is a person located at a distance from the person 11, in the same country or a foreign country. The person 11 uses his telephone 7 to call the person 22 on his telephone 4. Recognizing the person 22 from the sound of his voice and potentially the personal dialogue that ensues, the person 11 vocally provides the redemption code to the person 22.

According to a second possible use, the person 22 is close to the person 11. This is for example the case of two family members who live close to one another. The person 11 visually recognizes the person 22 and provides him with the redemption code orally or written on a piece of paper.

According to a third possible use, the person 22 is the holder of the account from which the sum of money is withdrawn, but does not have electronic authentication means such as a bank card or other similar means. The person 11 is then an employee in a branch of the bank managing the account. After having duly verified the identity of the person 22, the employee uses his personal peripheral of the bank computer on which he is authenticated to obtain the redemption code in the form of a paper receipt he provides to the person 22. The bank computer can also send the redemption code to the mobile telephone 4 directly by text message. The person 22 then uses the paper receipt or the text message to perform the requested withdrawal on the branch's ATM.

According to a fourth possible use, the person 22 and the person 11 are the same person, who wishes to withdraw a sum of money without having to bring his authentication device, for example his bank card, at the time of the withdrawal, for example coming from the gym or the beach. The person 11 then need only obtain the redemption code beforehand and memorize it or write it on the palm of his hand if he has less faith in the person 22 he will have become when returning from the gym.

Other uses, obtained by combining or extending the aforementioned uses, are possible without going beyond the scope of the present invention.

In particular, the terminal 1 may be used to deposit the sum of money if it is provided for that purpose. It is then the deposited sum that is transferred.

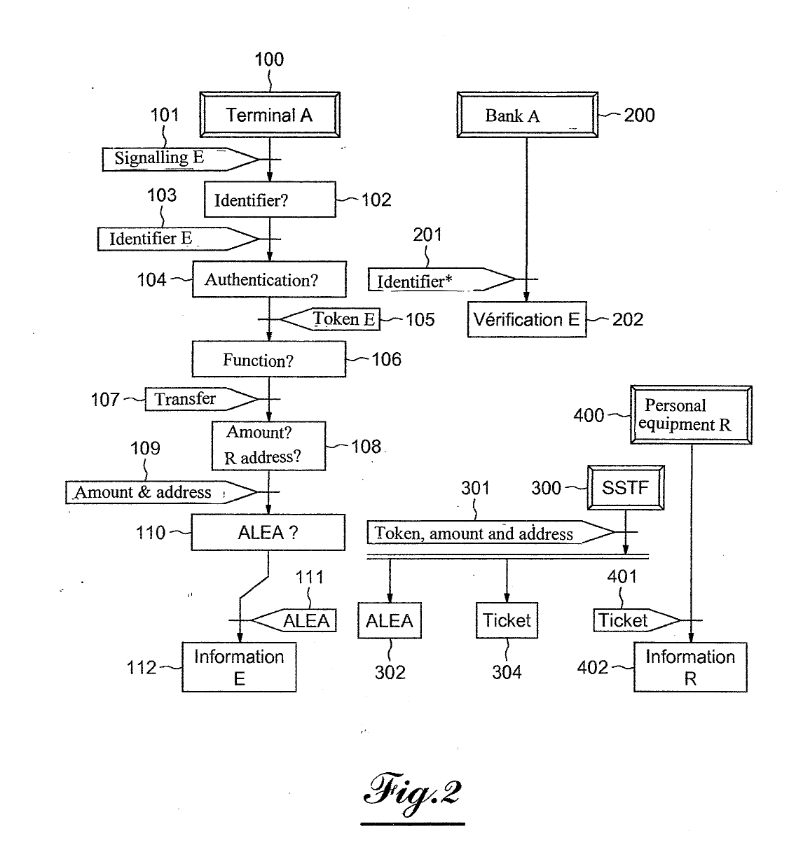

In reference to FIG. 2, a terminal of a first system A (hereafter terminal A), initially in a standby step 100, performs the steps of the method that allow a sender (E) to send an order to deliver a directly-usable sum of money to a remote recipient (R), the amount of which is withdrawn from an account managed by a bank computer of the system A (hereafter bank A). Typically, the terminal A and the bank computer A are respectively housed by the terminal 1 and the computer 2 of FIG. 1. The person E is then the sender 11 and the person R is than the recipient 22 of FIG. 1.

A signaling transition 101 is verified when the person E goes to the terminal A, which is for example an automated teller machine (ATM) of his bank or a bank that has an agreement with his bank. The terminal may also for example be an electronic payment terminal (EPT), or secure telecommunications equipment such as mobile a telephone comprising an encryption module. Various methods may be used to introduce oneself to the terminal A, for example such as inserting a personal information medium into a reader of the terminal A provided to that end. Non-limiting examples include magnetic stripe cards and chip cards according to the EMV standard or another standard ensuring international interoperability of monetary transactions. The personal information stored on medium is correlated with a confidential code (Personal Identification Number, PIN) secretly held by the person E or any other type of identifiers in particular comprising biometric data, such as a fingerprint, veins in the hand, a retina, or an iris that unambiguously distinguishes person E within the human race.

The validation of the transition 101 activates a query step 102 in which the terminal A asks the person E to provide his identifier by typing his confidential code on a keypad of the terminal or placing a suitable part of his body at a sensor of the terminal dedicated to the biometric data correlated with the personal information stored on the medium.

An identification transition 103 is validated when the person E has provided his identifier to the terminal A.

A validation of the transition 103 activates an authentication step 104 in which the terminal A sends the identifier to the bank computer A, preferably in encrypted form by the terminal A.

The bank computer A initially, in a standby step 200, performs the steps of the method that make it possible to connect the account of the person E to authorize performance of the order sent by the person E on the terminal A.

An account access transition 201 is validated when the bank computer A receives the identifier of the person E, preferably encrypted as indicated by the superscript star shown in FIG. 2.

A validation of the transition 201 activates a verification step 202 in which the bank computer A verifies the correlation between the identifier and the personal data of the person E and generates a token connected to the person E (token E) if the correlation is positively verified. The token is for example an encrypted element EMV. The bank computer A for example uses an ATM manager (GDG) to that end in a known manner. The bank computer A then sends the token E to the terminal A.

An authentication discharge transition 105 is validated when the terminal A receives the token E.

A validation of the transition 105 activates a selection step 106 in which the terminal A asks the person E to select a function from a menu from among several proposed monetary functions such as cash withdrawal, account balance, and more particularly in the context of the invention, a transfer consisting of delivering a sum of money personally to a person R.

Other known or future method steps in the field of remotely accessing a bank account may be used to carry out the preliminary phase that leads to step 106, from which the essential steps of the invention explained below are carried out. Steps 102 and 104 may for example be grouped together in a single step in the event biometric data detected by a sensor of the terminal A is sufficient for signaling and identification of the person E.

Independently of the manner in which it is obtained, the token E is the element that makes it possible to start and validate the secure transmission phase explained hereafter. The token generally becomes invalid once the secure transmission is complete.

A control transition 107 is validated when the person E selects a secure transmission according to the invention, in particular the “money transfer” function in the menu.

A validation of the transition 107 activates a formulation step 108 in which the terminal A asks the person E to indicate a code for designating an object to which the secure transmission pertains. When the secure transmission pertains to a money transfer, the designation code is the amount of money to be transferred. According to one preferred alternative embodiment of the method, the terminal also asks the person E for an unambiguous personal code which facilitates the processing of the secure transmission, as will be seen later in the description. The personal code is unambiguous inasmuch as it is specifically attached to the person E or the person R. The personal code is for example an address that makes it possible to reach the person R to inform him of the information necessary to withdraw the object to which the transmission pertains, in particular withdrawal of the sum of money to be delivered to him. Said address is for example an Internet messaging address. Preferably, said address is a telephone number at which it is possible to call the person R. Still more preferably, said address is a mobile telephone number, which generally makes it easiest to reach the person R and send him written information using short message service (SMS) or multimedia message service (MMS). Being able to reach the person R is not the only advantage of the telephone number, which also has the advantage of generally being memorized both by the person R and the person E or stored in an electronic directory, and consequently easily found both by the person E and the person R. In this respect, the telephone number may also be the telephone number of the person E that personally designates the person E, in other words which designates the person E unambiguously. The people E and R being people who know each other, it suffices for the person E to communicate his telephone number to the person R using any method whatsoever so that the person R retains it.

An information transition 109 is validated when the person E indicates the code designating the object, in particular the amount of money to be transferred, and preferably also the unambiguous personal code, in particular the mobile telephone number making it possible to reach the person R who will receive the sum of money. Preferably, the person E enters the amount to be transferred in the currency of the country where the person R lives. In other words, the amount is generally expressed in the currency where the person E resides essentially if the person R lives in the same country.

A validation of the transition 109 activates a request step 110 in which the terminal A asks the secure funds transfer server SFTS, typically the server 3 of FIG. 1, to provide a first redemption code ALEA. To that end, the terminal A sends the server SFTS a request that comprises the token emitted in step 202 by the bank computer A, the amount, and the address entered by the person E on the terminal A.

The security server SFTS, initially in a standby state 300, carries out the steps of the secure transmission method that make it possible to transmit the object, more specifically the sum of money, to the person R.

A startup transition 301 is validated when the server SFTS receives the request comprising the token that connects the account to be debited and the amount of the sum of money to be transferred. In the alternative that uses the unambiguous personal code, the request also comprises the address, in particular the telephone number making it possible to inform the person to whom the sum of money is to be delivered of the transfer.

A validation of the transition 301 activates a response step 302 in the server SFTS responding to the request emitted by the terminal A and a step 304 for generating an electronic withdrawal ticket for the sum of money.

In this step 302, the server SFTS creates a data structure dedicated to the secure transmission, in particular dedicated to the money transfer transaction, for example a line indexed by an identifier ID in a match table. In order to avoid needlessly making the text more complex, it will be understood in the rest of the description that the amount of the sum of money also more generally refers to the code designating any object that is not necessarily a sum of money. The identifier ID may also be a pointer in another type of data structure. The server SFTS stores, in the data structure, the values of parameters communicated in the request and comprising the token, the amount of money to be transferred with the address, in particular the telephone number making it possible to inform the recipient of the sum of money of the transfer, optionally a telephone number of the person E and/or a bank card number of the person E. The bank card number is for example obtained from the bank computer A using the token, with or without the terminal A. The server SFTS then draws a number, or more generally a random chain of characters, that constitutes the first redemption code ALEA, which is random or quasi-random. The server SFTS stores the code ALEA in a box of the data structure reserved for that word and sends the code ALEA in a response message to the terminal A, potentially via the GDG when the terminal A is a bank payment machine It will be noted that the code ALEA may also be generated in the form of a temporary PIN code that can be used a single time by the beneficiary. In that case, a hash code is preferable, in particular for two different people 11 and 22.

In the step 304, the server SFTS assigns the future withdrawal operation of the transferred sum of money a valid time range VTR that it stores in the data structure. The valid time range procures additional security for the transmission, which may thus not be performed outside the valid time range. Other additional security measures may be considered, for example the neighborhood of a valid location. The server SFTS applies a hash function to all or part of the content of the data structure, which provides a second redemption code Hash Data, of a deterministic nature. The server SFTS stores or does not store the Hash Data code in a box of the data structure, groups the second redemption code Hash Data together with the valid time range VTR and/or a location criterion for the withdrawal, so as to generate the electronic ticket, then send the electronic ticket in a notification message to the address of the personal equipment of the person R stored in the data structure. The notification message is advantageously sent in the form of an SMS when the address is a mobile telephone number. When no address of the person R is provided in the request, an address of the person R may be available from a database subject to prior registration therein. When no address for the person R is known in any manner, step 304 may not be carried out.

A discharge transition 111 is validated when the terminal A receives the first redemption code.

A validation of the transition 111 activates a signaling step 112 in which the terminal A communicates the first redemption code ALEA to the person E. Different embodiments may be considered to communicate the first redemption code ALEA to the person E, such as for example visually by displaying the code on a local screen, vocally using a speaker situated on the terminal A or a wireless connection using protocol 802.11 or near field communication (NFC) or other techniques toward a communication object held by the person E, for example such as a mobile telephone 7 equipped with a short-range radio receiver. In one preferred embodiment, the terminal A prints the amount of the sum to be transferred, the address of the personal equipment of the person R, and the first redemption code ALEA on a receipt that is given to the person E.

An alert transition 401 is validated when the personal equipment of the person R, typically the telephone 4, receives the electronic ticket.

A validation of the transition 401 activates an alarm step 402 in which the personal equipment of the person R informs the person R so as to allow him to read the contents of the electronic ticket to take cognizance of the second redemption code and the time range within which the sum of money may be withdrawn.

The steps 304 and 402 may be incorporated into an option in the context of which the method proposes to the person E, a.k.a. the “payer,” to notify the person R, a.k.a. the “payee,” of the future transfer by a text message or telephone call combined with a voice synthesis device, if the Payee has a mobile telephone. Independently of this option, the address communicated in the request of step 110 in the form of a telephone number allows the person E to indicate the person R, and allows the person R to be recognized easily by associating the person R with the telephone number that is easy to remember both for the person E and the person R. In a way, the telephone number is a sort of unambiguous name code for the person R, as we will see now in the rest of the description.

However, the steps may only be optional if the generated code ALEA also subsequently serves as the transaction key to locate the ticket.

In the case of the transfer, steps 302 and 304 are not optional. This step 304 in particular serves to send the virtual card number that is generated based on the Hash Code and using the method described hereafter.

Ideally, the SFTS builds a special card number comprising a specific bank identification number (BIN) in the fixed portion that makes it possible to identify the banking establishment to which the sender of the transfer belongs. The BIN is followed by a number correlated to the code ALEA, for example the code ALEA in clear or the encrypted code ALEA. The correlated number may also be the Hash data, in particular if the code ALEA is comparable to a temporary PIN code.

A notation appears here comparable to that found in domain name servers (DNS) to ultimately find the card number of the sender (as in TCP/IP) with several networked SFTS servers, each attached to a bank server, for example here such as the server 2 of Bank A and the server 6 of Bank B.

The virtual card number or virtual PAN is an alias for the bearer's card number whereof the BIN makes it possible to escalate to the sender and find the server SFTS of the sender's bank, and the variable portion of which corresponds to the hash code, which makes it possible to find the ticket in the server SFTS of the sender's Bank.

Two advantages made possible the type of architecture just described will be noted.

A first advantage lies in associating a T-PIN code with the virtual card number that does not modify the transfer of data between the withdrawal machine 5 and the computer 2 of Bank A.

A second advantage lies in using two different transmission channels for these two pieces of information, which strengthens security.

The step 112 ends with the first phase of the method that provides the person E with an intangible verification key over the transfer of the sum of money he is ordering. This immaterial verification key consists of the first redemption code ALEA.

In a second phase, the Payer, i.e. the person E, personally provides the redemption code ALEA to the Payee, i.e. the person R, in a humanly-verifiable manner, for example vocally, directly or using a telephone, by delivering it personally, or using any other equivalent conventional means that makes it possible to ensure that the person receiving the redemption code is indeed the person R for whom the transfer of money is intended. The meeting or conversation during which the person E provides the code ALEA to the person R allows the person E to recognize the sound of the voice, the facial features of the person R and/or information shared, for example on the family. In this respect, the mobile telephones 7 and 4 are particularly well-suited means for establishing a voice or video communication channel between the people E and R.

In particular when the person R is far away, telephone communication allows the person E to ensure that the information of the code ALEA is indeed transmitted to the right person. Internet-based electronic messaging devices (EMAIL) or short message services (SMS) are a priori rejected from the method, as they are sources of error, unless the numbers or e-mail addresses of the Payees (People who are potentially R) are pre-saved with prior verification of that data before any transaction.

The person R, i.e. the Payee, having received the code ALEA by voice and, optionally, having been notified by SMS in the event step 402 is carried out on his personal communication equipment, activates the second phase of the method by going to a machine of a bank having an agreement with the bank of the person E, i.e. the Payer, or a machine of a bank having signed up for the “Money Transfer” service with the same operator as the bank of the person E to carry out the method according to the invention.

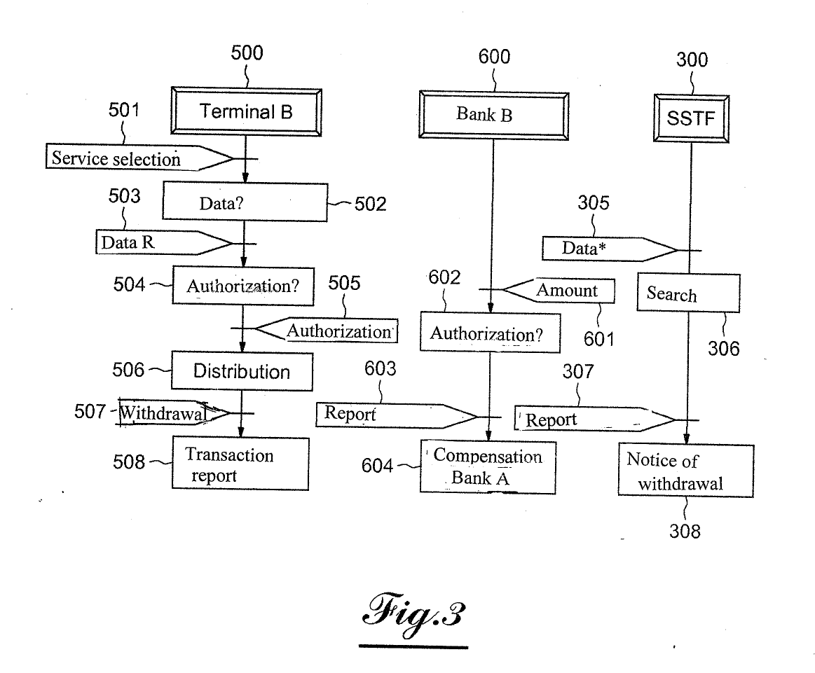

In reference to FIG. 3, the terminal of a second system B (hereafter terminal B), which is initially in a standby step 500, carries out steps of the method that allow the person R to withdraw the sum of money sent by the remote person E, and the amount of which is debited by compensation from a bank computer of the system B (hereafter bank B). In step 500, the terminal B typically displays a menu of several possible functions or services, comprising, purely as a non-limiting illustration, a cash withdrawal, account balance, and more particularly in the context of the invention, the money transfer and receipt of the transfer money.

A selection transition 501 is validated in the terminal B when a person, in particular the person R, selects the “Receive money” function.

A validation of the transition 501 activates a step 502 in which the terminal B displays an electronic form that asks the person R to enter, successively or randomly, a set of data comprising:

the amount of the sum to be received in the local currency of the location where the terminal B is installed;

the first redemption code ALEA that the person R has received from the person E vocally; and potentially

depending on the selected embodiment option, the unambiguous personal code, for example the telephone number of the person R, and/or all or part of the content of the electronic ticket, for example the second redemption code Hash Data.

Preferably, a hash code and/or telephone number transaction identifier is in particular useful if the code ALEA is comparable to a temporary PIN, generally short to facilitate searching for the transaction in the database of the SFTS.

It will be noted in this respect that when two redemption codes are entered, they are a priori different and are both entered by the person R.

A data reception transition 503 is validated in the terminal B when all of the required data has been received.

A validation of the transition 503 activates a request step 504 in which the terminal B asks the secure funds transfer server SFTS to provide a withdrawal authorization. The authorization request comprises the data requested in step 502 by the terminal B, in particular the amount and the code ALEA entered by the person R on the terminal B and, optionally, the second withdrawal code corresponding to the hash code received during the optional steps 304 and 402, in particular if the code ALEA is comparable to a temporary PIN code.

Different methods of conveying the request to the secure funds transfer server SFTS are possible.

For example, when the terminal B takes the form of a bank machine, it first sends the authorization request to the management service GDG of the bank computer B. The amount and currency are normally sent according to the rules of the protocol used by the machine to dialogue with the bank computer B (HOST-GBG). The bank computer B, then identifying a specific Funds Transfer request in the authorization request owing to the BIN, routes the request data to the SFTS.

The secure server SFTS, which is initially in a standby step 300, carries out the sequence of steps of the method that make it possible to transfer the sum of money from the person E to the person R.

A data reception transition 305 is validated when the server SFTS receives the data of the request, in particular comprising the amount and the code ALEA.

A validation of the transition 305 activates a search step 306 in which the SFTS (or the SFTS network) verifies the validity of the code ALEA and checks the amount with its currency. Optionally, it is also possible to verify the hash data. After having positively performed all checks and verifications, the secure server SFTS returns an authorization to the bank computer B (HOST-GDG) with the amount and the Bank Card identification number (Personal Authentication Number, PAN) of the Payer, i.e. the person E. The transaction to which the validation of the transition 305 pertains may be found by indexing the code ALEA if it is quasi-random so as to be unambiguous, by indexing the amount on a first level and then the code ALEA on a second level. Preferably, the transaction is found by indexing the unambiguous personal code specially transmitted to that end by the person R on the terminal B.

An approval transition 601 is validated when the bank computer B receives the amount approved by the secure server SFTS.

A validation of the transition 601 activates a step 602 in which the bank computer B sends the terminal B a response to the authorization request. The response may be developed in various ways, for example by direct retransmission of the approved amount to the terminal B. Preferably, when the approved amount is accompanied by the PAN of the person E, the bank computer B starts by rerouting the authorization request in modified form with the Bank Card number of the Payer to its standard authorization server (HOST-SA) so as to escalate to the bank computer A of the Payer according to the standard authorization systems. In this particular case, the bank computer B only sends the terminal B the authorization to issue the funds, i.e. to deliver the sum of money to which the transfer pertains, upon receipt of the authorization from the bank computer A.

An authorization transition 505 is validated when the terminal B receives a positive response to the authorization request it emitted in step 504.

A validation of the transition 505 activates a distribution step 506 in which the terminal B performs a final check and proceeds to issue the sum of money, for example by distributing banknotes in a quantity corresponding to the amount of the transferred sum. When it assumes the form of a bank machine, the terminal B traditionally verifies the authorization received from the bank computer B (HOST-GDG) to perform the final check.

A withdrawal transition 507 is validated when the person R withdraws the bills.

A validation of the transition 507 activates a step 508 in which the terminal B generates a report on the transaction that it sends to the bank computer B and optionally to the secure server SFTS.

A confirmation transition 603 is validated when the bank computer B receives the report.

A validation of the transition 603 activates a step 604 in which the bank computer B compensates the sum of money with the bank computer A in a known manner.

A confirmation transition 307 is validated when the secure server SFTS receives the report.

A validation of the transition 307 activates an optional step 308 in which the secure server SFTS provides a notice to the person E that a withdrawal has been done. If the telephone number 7 of the person 11 is stored in a secure server SFTS 3, the secure server SFTS may provide the notice that a withdrawal has been done directly on the telephone 7, for example by sending an SMS.

It will be noted that, unlike certain methods of the state of the art in which information comprising a secret and a transaction identifier are sent from a payer to a payee using a single channel with the drawback of favoring interception, in the method and system according to the invention, a code obtained using a hash function to seal a set of elements of the transaction is conveyed through a second channel, in this case an SMS, that is different from the first channel for conveying the secret code shared by the people E and R based on mutual recognition. This hash code, which signs the transaction and serves to identify the transaction on the payee side, can only be generated and verified by the server SFTS. This hash code, which constitutes the second redemption code, may only be reconstructed if one has the keys of the server SFTS used to generate it and the data escalated either by voice (in particular the secret, etc.) or by SMS (OTP, Amount, Mobile phone number of the payee, etc.).

The SMS is an effective way to send the data to the payee, i.e. the person R, who will be fully able to reproduce that information during redemption. It remains unusable, however, without the secret, i.e. the first redemption code that is transmitted by voice.

Assuming that the person E decides to send the secret, i.e. the code ALEA, by SMS as well to the person R, thereby introducing a risk of interception of both SMSs in the event of corruption of the then-single transmission channel, the invention proposes additional security measures explained below.

Furthermore, the method according to the invention offsets any mistakes on the authentication of the person R following an error in the telephone number of the person R by requiring the person E to enter the payee number twice, i.e. once on the first terminal, in particular on the bank machine for which the person E cannot use his telephone directory, thereby avoiding selection errors in a phone book, and once on his mobile telephone for the voice call or to send the SMS if the person E decides to use that channel in the absence of means to prevent him from doing so.

If the person E makes a mistake in entering the telephone number of the person R on the machine, the SMS sending the ticket from the server SFTS may reach an undesired recipient, but the SMS will be unusable without the secret consisting of the first redemption code ALEA.

If the person E makes a selection error in sending the secret by voice, the person E will recognize his error immediately, for example by detecting an unknown voice.

If the person E correctly enters the number of the person R on the machine and then decides to send the secret, i.e. the first redemption code ALEA by SMS. Any error in the number of the person R made by the person E from his mobile telephone 7 has no harmful consequences, since the erroneous recipient will receive a secret that he will not know what to do with without having the SMS sent from the server SFTS.

If the person E enters the information incorrectly on the machine, then decides to send the secret by SMS by selecting the correct number for the person R, the recipient of the first SMS will not be able to use it without the secret.

The risk of error is also considered if the person E uses the same wrong number twice, both on the machine to create the transaction and on his mobile telephone to send the secret to the person R, the erroneous recipient than having all of the information needed to perform the withdrawal.

Although the above risk is limited by the fact that the person R is an acquaintance of the person E and in that case the person E has a correct number in his phone book, without having to type the number directly on his mobile telephone, the method can be improved by countering that risk using the following means.

A criterion is added relative to the location of the machine where the redemption may be done. The erroneous recipient is not very likely to be in the vicinity of the localized machine to perform the redemption within the timeframes set out by the time range.

Preferably, the method can provide for pre-storing, on the ATM management side of the person's E bank, of the mobile phone numbers of people R who may potentially be authorized to receive money transfers. This option may have an advantage in the context of laws on the transfer of currency and money laundering.

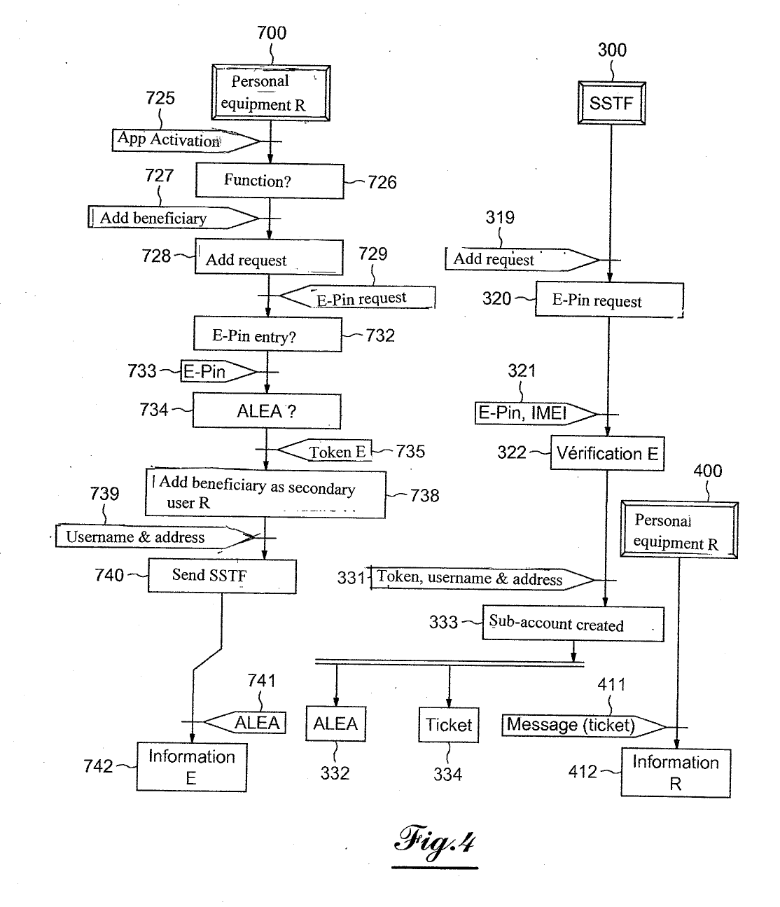

In reference to FIG. 4, personal sending equipment allocated to the sender (hereafter personal equipment E), which is initially in a standby step 700, carries out the steps of the method, called enrollment, that allow the sender (E) to send an order to provide means to a remote recipient (R) to access a sub-account of the account associated with the personal equipment E under the control of the secure server SFTS. Typically, the personal equipment E is the mobile telephone 7 of FIG. 1, which hosts a secure access program for accessing the account controlled by the secure server 3. The secure access program comprises instructions executable by a microprocessor of the personal equipment in the form of a script or an applet so as to implement the method according to the invention. Compared to an interpreted script, the compiled applet has the advantage of greater speed and more user-friendliness. The applet is loaded beforehand using a downloading method known in the technical field. The person E is typically the sender 11 and the person R is then the recipient 22 of FIG. 1.

A signaling transition 725 is validated when the person E activates the applet on his personal equipment. The applet installed on the personal equipment for example comprises the instructions and data, preferably encrypted, that make it possible to emulate, in connection with the data for the account of the person E open in the database of the secure server SFTS, a card according to the EMV standard or another standard ensuring international interoperability of monetary transactions. The personal information stored on the medium is correlated with a confidential code (Electronic Personal Identification Number, E-PIN) secretly held by the person E or any other type of identifier in particular comprising biometric data, such as a fingerprint, veins in the hand, a retina or an iris that unambiguously distinguish the person E within the human race.

The validation of the transition 725 activates a query step 726 in which the applet activated on the personal equipment displays a menu of different available teletransmission functions which non-limitingly include those pertaining to an object that is a sum of money or an object that is a sub-account of the primary account accessible using the confidential code E-PIN.

A transition 727 is validated when the sender selects a function in the menu to add an account beneficiary.

A validation of the transition 727 activates a step 728 that retransmits the add request to the secure server SFTS, typically the server 3 of FIG. 1.

A transition 319 is validated when the server SFTS receives the add request.

A validation of the transition 319 activates a step 320 in which the secure server sends the personal equipment an E-PIN code request.

A transition 729 is validated when the personal equipment receives the E-PIN code request from the secure server SFTS.

A validation of the transition 729 activates a step 732 in which the applet activated on the personal sender equipment asks the sender 11 to enter his confidential E-PIN code, for example on the keypad of the personal equipment E.

An identification transition 733 is validated when the person E has provided his identifier to his personal equipment.

A validation of the transition 733 activates an authentication step 734 in which the personal equipment sends the E-PIN identifier to the server SFTS, preferably encrypted by an encryption module of the personal equipment. The step 734 consists of asking the secure server for a random or quasi-random single-use temporary redemption code called ALEA for the circumstances. The temporary redemption code will allow the recipient 22 to withdraw from the access parameters for the sub-account or limited access to the primary account. The transmission of the E-PIN identifier to the server SFTS is accompanied by the International Mobile Equipment Identity (IMEI) number of the personal sending equipment.

A transition 321 is validated when the secure server receives the E-PIN code and the IMEI number.

A validation of the transition 321 activates a step 322 in which the secure server looks for the user account associated with the IMEI number and verifies that the E-PIN code allows access to the located user account. If the verification is positive, the secure server generates the code ALEA and stores the code ALEA or a seed for generating that code in memory. This code ALEA is different and completely independent from other codes ALEA generated at other moments in the step 322 for other users or generated for other uses in other steps, for example in the step 302. The code ALEA is not necessarily generated in step 322, but may also be generated in a later step 332 explained later in the description. In fact, at the end of the step 322, the secure server preferably simply sends the personal equipment a correct E-PIN code discharge, for example in the form of a token E according to the EMV standard.

A transition 735 is validated when the personal equipment E receives the token E.

A validation of the transition 735 activates a step 738 in which the personal equipment E, which continues to execute the activated applet, asks the sender to specify the beneficiary to be added as a secondary user R.

A transition 739 is validated when the sender enters an address for personal receiving equipment (R) on the personal equipment E, for example in the form of a mobile telephone number when the personal equipment R is a mobile telephone 4. The sender also enters a username for the authorized user of the account, preferably under supervision by the sender, who is the primary account holder.

A validation of the transition 739 activates a step 740 in which the personal equipment E sends the secure server the address and username, potentially accompanied by the token E.

A transition 331 is validated when the secure server receives the data transmitted in step 740.

A validation of the transition 331 activates one or several steps 332, 333, 334.

The step 333 consists of creating a data structure containing a transaction identifier, the recipient address, which is preferably a mobile telephone number of a secondary user, the IMEI number of the primary user, i.e. of the personal sending equipment, the redemption code ALEA, an enrollment time range, and hash data.

The step 332 consists of sending the code ALEA to the personal sending equipment preferably using an MS-ISDN (Mobile Station Integrated Services Digital Network) authentication. When the personal equipment E is a mobile telephone 7, the code ALEA is sent in an SMS.

Step 334 consists of sending the personal equipment R assigned to the recipient a ticket by short message SMS comprising at least the time range and hash data.

A transition 741 is validated when the personal equipment E receives the redemption code ALEA.

A validation of the transition 741 activates a step 742 that consists of visually or vocally displaying the code ALEA for information for the sender.

A transition 411 is validated when the personal equipment R receives the message associated with the ticket.

A validation of the transition 411 activates a step 412 that consists of signaling the receipt of the message containing data that in particular comprises the time range and the hash data for information for the recipient. Preferably, this operation is only possible at a bank counter so as to allow an additional verification operation through human intervention.

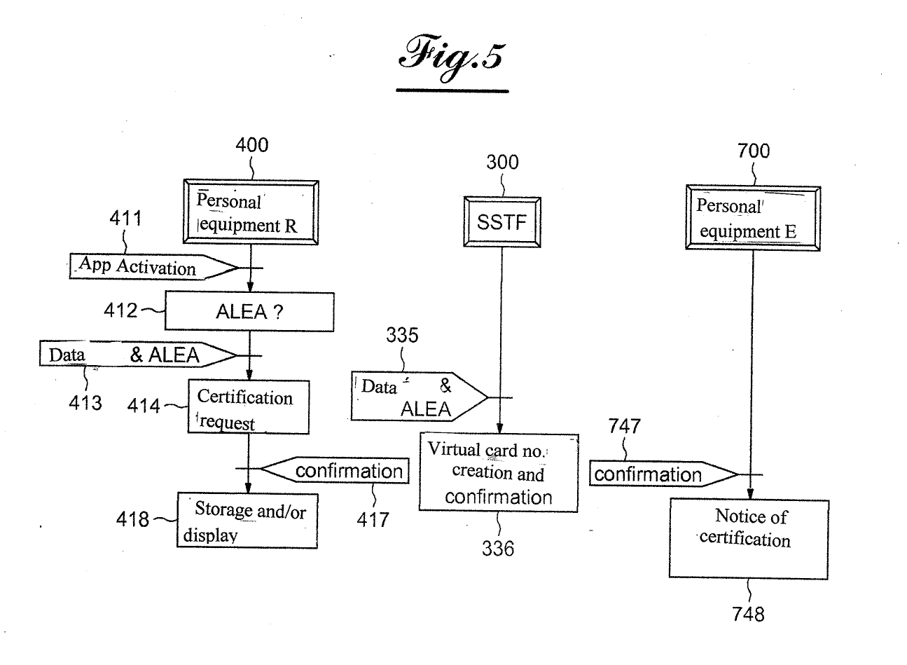

In reference to FIG. 5, a transition 411 is validated when the recipient opens the message received in step 412.

A validation of the transition 411 activates a step 412 that displays the SMS message on a screen of the personal equipment R. The text of the message contains a request to enter the redemption code ALEA.

Secondarily, the sender calls the recipient on his personal equipment R. When the recipient answers, the sender recognizes the sound of his voice or his physiognomy when video is possible. The sender can thus ensure that the personal receiving equipment is allocated to the proper recipient. After verifying the recipient, the sender provides him with the redemption code ALEA such that the recipient can then enter the redemption code ALEA in the body of the message open in step 412.

A transition 413 is validated when a response message containing the data and the code ALEA is placed in the outbox of the personal sending equipment. The received message already containing the data, the recipient need only complete it with the code ALEA to return it in the form of a response.

A validation of the transition 413 activates a step 414 that consists of sending a certification request to the secure server SFTS in the form of a reply message containing the data and the code ALEA.

A transition 335 is validated when the secure server receives the data and the code ALEA from the personal equipment R.

A validation of the transition 335 activates a step 336 in which the secure server SFTS checks the time range and verifies that the code ALEA is correlated with the hash data. It is possible to consider manual verification with the operator to identify the secondary user with his actual identity. After a positive verification, the secure server SFTS creates a virtual card number associated with the sender's account matched with the personal equipment R of the recipient, then listed with the username previously provided. The virtual card may be available for multiple uses or a single use with a personal authentication number (PAN) generated immediately or later depending on the usage type. The secure server then sends an account creation confirmation by SMS to the personal equipment of the sender, who is the primary user, and the personal equipment of the recipient, who is the secondary user.

The reception of a first confirmation SMS by the personal equipment of the sender validates a transition 747, which activates a certification notice step 748.

The reception of a second confirmation SMS by the personal equipment of the recipient validates a transition 417 that activates a confirmation notice step 418 comprising storage or a display of the virtual card number contained in the second confirmation SMS.

From this step, money may be withdrawn on a bank terminal with the personal equipment R using a known withdrawal method based on a mobile telephone that emulates a virtual bank card or using a method based on that previously explained in reference to FIG. 3.

To increase security and allow verification of each withdrawal by the primary user, the secure server may generate a temporary personal identification number T-PIN for each withdrawal following the model of the code ALEA that is communicated orally each time by the primary user to the secondary user.

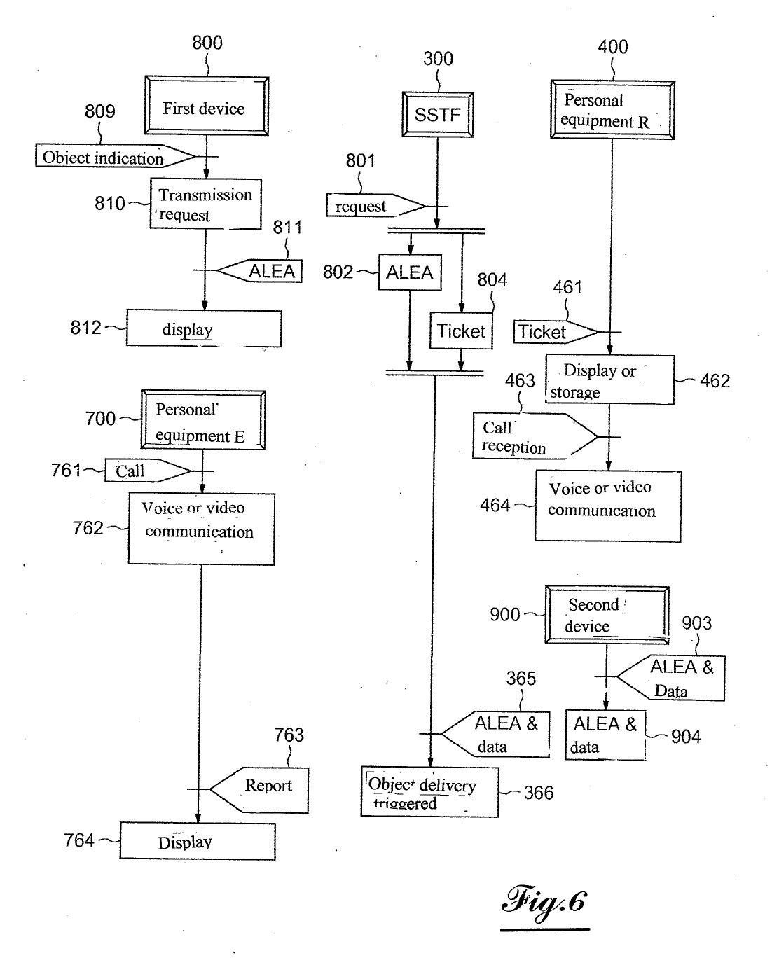

FIG. 6 shows the essential steps of the method according to the invention, which applies to the first embodiment presented in reference to FIGS. 2 and 3 and the second embodiment presented in reference to FIGS. 4 and 5, as well as any other embodiment that requires ensuring that personal receiving equipment participating in a teletransmission is in fact allocated to the recipient to whom a sender wishes to send the object of the teletransmission.

The secure teletransmission method ordered by the sender 11 destined for the recipient 22 comprises the preparation steps that are carried out using a first electronic device in the possession of the sender to order the teletransmission.

Starting from a monitoring step 800 of the first electronic device, a transition 809 is validated when the sender indicates the object to which the teletransmission pertains and the address, telephone number, or any other suitable type of contact information for the personal receiving equipment.

A validation of the transition 809 activates a step 810 that consists of sending a teletransmission request to the secure server SFTS, which is initially in the standby step 300.

In the embodiment of FIGS. 2 and 3, the first electronic device is typically the first bank terminal 1. In the embodiment of FIGS. 4 and 5, the first electronic device is typically the mobile telephone 7.

In the secure server 3 that is the hub in the embodiment made possible by the invention, a first primary step 802 and a second primary step 804 are activated by a transition 801 that is validated when the secure server 3 receives the first request containing the code designating the object and the address of the personal receiving equipment allocated to the recipient from the first electronic device. The personal receiving equipment is typically the mobile telephone 4.

The first primary step 802, which corresponds to the step 302 of FIG. 2 or step 332 of FIG. 4, essentially consists of providing the first electronic device with a redemption code ALEA.

The second primary step 804, which corresponds to step 304 of FIG. 2 or step 334 of FIG. 4, essentially consists of providing the personal receiving equipment with the ticket containing data that comprises at least the code designating the object to which the teletransmission pertains in clear or encrypted.

The reception of the code ALEA in the first electronic device validates a transition 811 that activates a step 812 essentially consisting of displaying the code ALEA so that the sender may take cognizance thereof.

The reception of all or part of the ticket in the personal receiving equipment validates a transition 461 that activates a step 462 essentially consisting of storing, in the personal receiving equipment, or displaying the data of the ticket that is useful in performing the teletransmission from the personal receiving equipment.

The personal equipment E, typically the mobile telephone 7, is then used to carry out a first peripheral step 762 activated by a transition 761 that is validated when the sender 11 sends a call to the personal receiving equipment R, typically the mobile telephone 4.

The personal equipment R, typically the mobile telephone 4, is then used to carry out a second peripheral step 464 activated by a transition 463 that is validated when the recipient 22 takes the call initiated from the personal sending equipment E.

The peripheral steps 762 and 464 essentially consist of allowing the sender 11 to recognize the recipient 22 so as to ensure that the personal receiving equipment R is in fact allocated to the recipient 22 so as to provide him with the redemption code ALEA vocally or by video for a recipient who is hard of hearing.

A second electronic device, which is initially in a standby step 900, typically the bank terminal 5 for the embodiment of FIGS. 2 and 3 or the mobile telephone 4 for the embodiment of FIGS. 4 and 5, is used to carry out a step 904 for communication of the code ALEA and the data by the recipient to the secure server. The step 904 is activated by a transition 903 that is validated when the data and the code ALEA are introduced into the second electronic device.

When the second electronic device is the bank terminal 5, the data displayed in the step 462 and the code ALEA communicated in the step 464 are introduced by the recipient.

When the second electronic device is the mobile telephone 4, the data stored in the step 462 already lives in the second electronic device. Only the code ALEA communicated in the step 464 is introduced by the recipient.

A third primary step 366 is activated by a transition 365 that is validated when the secure server 3 receives, from the second electronic device 4 or 5, the redemption code ALEA and all or part of said data comprising at least the code designating the object in the form of a second request.

The third step 366, which corresponds to the step 306 of FIG. 2 or step 336 of FIG. 3, essentially consists of verifying a match between the redemption code ALEA and at least the code designating the object to supply the object of the teletransmission to the recipient 22 when the match between the codes is positively verified.

Secondarily, a step 764 is activated by a transition 763 that is validated when the personal equipment E receives a report of the teletransmission from the secure server 3. The step 764 essentially consists of displaying the report.

1. A secure teletransmission method for sending of a message by a sender to a recipient comprising:
a first primary step and a second primary step that are activated when a secure server receives a first request from a first electronic device, wherein
the first request contains a designation code designating an object to which the teletransmission pertains and an address of personal receiving equipment that is assigned to the recipient,
the first primary step includes providing the first electronic device with a first redemption code and sending the first redemption code to the personal receiving equipment, using the first electronic device, and
the second primary step includes providing the personal receiving equipment with a ticket containing data comprising at least a second redemption code for designating the object to which the teletransmission pertains; and
a third primary step that is activated when the secure server receives a second request from a second electronic device, the second request containing the first redemption code and the second redemption code, wherein the third primary step includes verifying that the first redemption code matches the second redemption code and provides the object to the recipient when a match between the codes has been positively verified.

2. The method according to claim 1, wherein the first redemption code and the ticket, comprising at least the second redemption code, are sent to the personal receiving equipment using two different transmission channels to reinforce security.

3. The method according to claim 2, wherein the first electronic device sends the first redemption code to the personal receiving equipment vocally, either directly, or using a telephone.

4. The method according to claim 2, wherein the ticket, containing the data comprising at least the second redemption code, is sent by the secure server to the personal receiving equipment as a short message.

5. The secure teletransmission method according to claim 1, comprising:
a first peripheral step that is activated when the sender sends a call from personal sending equipment to the personal receiving equipment; and
a second peripheral step that is activated when the recipient takes the call sent from the personal sending equipment, wherein
the first peripheral step and the second peripheral step include enabling the sender
to recognize the recipient to ensure that the personal receiving equipment is assigned to the recipient, and
to send the recipient the first redemption code.

6. The secure teletransmission method according to claim 1 wherein the first electronic device is a first terminal, the second electronic device is a second terminal, the method comprising:
a formulation step in which the first terminal, upon receiving a verification token, asks the sender to indicate the second redemption code for designating the object to which the teletransmission pertains;
a request step in which the first terminal sends the secure server a request including the verification token and the designation code to ask the secure server to provide the first redemption code;
a signaling step in which the first terminal communicates the first redemption code to the sender; and
a distribution step in which the second terminal completes the transmission by delivering the object, after reception of the second redemption code and the designation code entered by the recipient, and after reception of an authorization emitted by the secure server and confirms the correlation between the second redemption code entered and the verification token.

7. The method according to claim 6, wherein
in the formulation step, the first terminal asks the sender to indicate at least one unambiguous personal code of the recipient and/or the sender; and
in the request step, the first terminal places the unambiguous personal code(s) in the request sent to the secure server.

8. The method according to claim 7, wherein, in the distribution step, the second terminal delivers the object after additionally receiving at least one unambiguous personal code entered by the recipient.

9. The method according to claim 7, wherein the unambiguous personal code is a telephone number.

10. The method according to claim 7, wherein
the unambiguous personal code is a telephone number of the recipient, and
the recipient receives the designation code by telephone on a first communication channel connected to the secure server and receives the first redemption code on a second communication channel connected to the sender.

11. The secure teletransmission method according to claim 5, wherein
the first electronic device is the personal sending equipment for accessing an account controlled by the secure server,
the second electronic device is a terminal,
the method includes creating a sub-account that is accessible from the personal receiving equipment when the secure server recognizes an add request from the personal equipment, and
the data supplied in the second main step comprises access information for the sub-account.

12. The secure teletransmission method according to claim 1, comprising
displaying data received by the personal receiving equipment from the secure server; and
an authorization request step sent to the secure server when the data received is entered with the first redemption code in the terminal.

13. The method according to claim 1, wherein a temporally-limited and/or spatially-limited validity is associated with the first redemption code.

14. The method according to claim 1, wherein the object is money and the designation code is the sum of the money.

15. The method according to claim 1, wherein
the object is a sub-account,
the designation code is a username of the sub-account, and
the second electronic device is the personal receiving equipment.

16. The method according to claim 15, wherein, in the third primary step, the secure server creates a virtual card number.

17. A secure teletransmission system for transmitting a message destined for a receiving person and ordered by a sending person, the system comprising:
a first electronic device available to the sender;
personal receiving equipment allocated to the recipient;
a secure server comprising a program for supplying a redemption code to the first electronic device and supplying a designation code, designating the object to which the teletransmission pertains to the personal equipment; and
a second electronic device comprising an interface allowing the recipient to enter at least the first redemption code, means for connecting to the secure server to send the redemption code and the designation cod; and to receive authorization from the secure server confirming a correlation between the entered redemption code and the designation code, and automatic delivery means for the object after receipt of the authorization.

18. The system according to claim 17, comprising personal sending equipment allowing the sender to call the personal receiving equipment to ensure that the personal receiving equipment is assigned to the recipient.

19. The system according to claim 17, wherein the first electronic device is a first terminal comprising an interface arranged to ask the sender to indicate at least one unambiguous personal code of the recipient and/or the sender to place the unambiguous personal code(s) in a request sent to the secure server.

20. The system according to claim 19, wherein the second electronic device is a second terminal arranged to deliver the object after additional receipt of at least one of the unambiguous personal codes entered by the recipient.

21. The system according to claim 19, wherein the unambiguous personal code is a telephone number.

22. The system according to claim 19, wherein the unambiguous personal code is a telephone number of the recipient, and the recipient receives the designation code by telephone on a first communication channel connected to the secure server, and the redemption code on a second communication channel connected to the sender.

23. The secure teletransmission system according to claim 18, wherein
the first electronic device is the personal sending equipment containing a program for accessing an account controlled by the secure server,
the second electronic device is personal receiving equipment, and
the secure server is arranged to receive an add request from the personal equipment, to create a sub-account accessible from the personal receiving equipment, and to send the personal receiving equipment data comprising access information for the sub-account.

24. The system according to claim 17, wherein the secure server is arranged to temporally and/or spatially limit a validity associated with the redemption code.

25. The system according to claim 17, wherein the object is money and the designation code is the sum of the money.

26. The system according to claim 17, wherein the object is a sub-account, the designation code is a username for the sub-account, and the second electronic device is the personal receiving equipment.
